(19) United States
(12) Patent Application Publication
(10) Pub. No.: US 2018/0207781 A1
(43) Pub. Date: Jul. 26, 2018

(54) Nail straightening hammer and method of using same

(71) Applicant: William Anthony Lanza, Newington, CT (US)

(72) Inventor: William Anthony Lanza, Newington, CT (US)

(21) Appl. No.: 15/530,496

(22) Filed: Jan. 23, 2017

(51) Int. Cl. B25D 1/04; B25G 1/10; B25C 13/00

(52) U.S. Cl. CPC B25D 1/04; B25C 13/00; B25G 1/10

(57) ABSTRACT

A nail straightening hammer has a conventional handle and head with a elongated straightening chamber in the handle.

### BACKGROUND OF THE INVENTION

Bent nails are a common occurrence when manually driving nails with a conventional claw hammer. Various means for straightening nails are currently available but are not wholly satisfactory. Tapping the bent portion of the nail with the driving surface of the hammer in a direction opposite the bend may result in partial straightening of the nail accompanied by partial rotation of the nail or merely in useless rotation of the nail. Grasping the bent portion of the nail with the claw and manipulating the handle manually is awkward and often results in a nail bent in a new direction. Using pliers to straighten the nail is effective but requires laying the hammer aside, locating and manipulating the pliers to straighten the nail, and then returning one's attention to the hammer.

### Object

It is the general object of the present invention to provide a means for straightening nails which is simple, convenient, easy to manipulate manually and highly effective in straightening nails.

A further object of the invention resides in the provision of methods for using the straightening means for various types of bent nails.

### SUMMARY OF THE INVENTION

In accordance with the present invention and in fulfillment of the foregoing objects, a nail straightening hammer is provided with a conventional elongated handle for manual manipulation. A head of hardened material is fixedly secured to the handle at one end or, alternatively, the handle and head may be of unitary construction as in a metallic or plastic embodiment of the invention. The head may have a claw and a substantially flat nail driving surface substantially parallel with but spaced laterally from the longitudinal centerline of the handle. At the end of the handle opposite the head an elongated nail straightening chamber is provided. The chamber preferably opens through the end surface of the handle and has a cross sectional configuration slightly larger than the head of the largest nail to be encountered. The length of the chamber is approximately the same as or slightly less than that of the longest nail to be encountered.

The methods of the invention are directed to various types of bends encountered and will be disclosed in detail hereinbelow.

### DRAWINGS

FIG. 1 is a perspective view of the nail straightening hammer of the invention,

FIG. 2 is a further perspective illustrating the hammer of the invention bending a nail with a single bend to a straight attitude,

FIG. 3 is a further perspective showing a nail with a double bend being bent to a straight attitude, and

FIG. 4 is still another perspective showing a nail projecting from the rear surface of a member being bent to a straight attitude.

### PREFERRED EMBODIMENT OF THE INVENTION

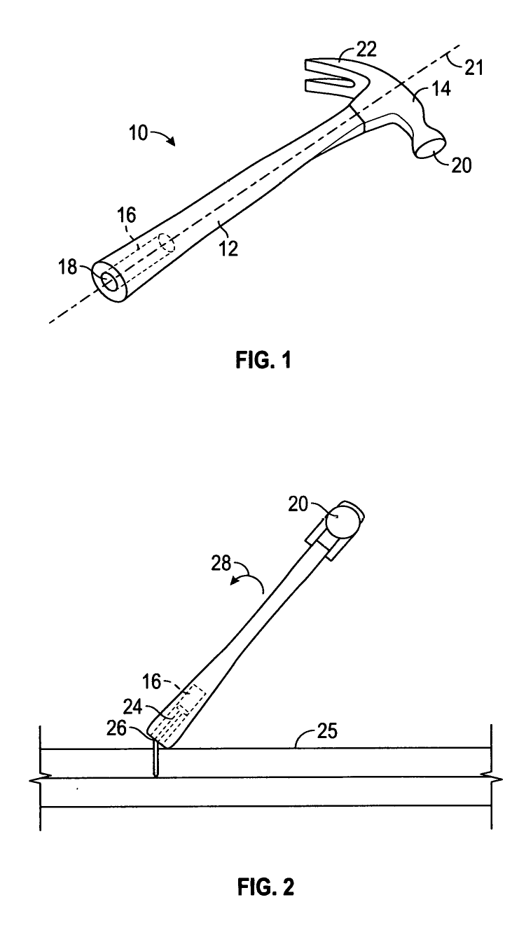

Referring initially to FIG. 1, a nail straightening hammer is indicated generally at 10 and has an elongated handle 12 and a head 14. As shown, the handle 12 is constructed of wood and the head is of a discrete hardened material and is fixedly secured to the handle at one end. Alternatively, the handle and head may be of unitary metallic, plastic or fiberglass construction. A substantially flat nailing face 20 on the head is parallel with but laterally displaced from the longitudinal centerline 21 of the handle. A conventional claw 22 is formed on the head opposite the nailing face 20. At the end of the handle opposite the head a nail straightening chamber 16 is provided.

The chamber is shown elongated along the centerline of the handle and opens through the end surface of the handle at 18. The cross sectional configuration of the chamber 16 is slightly larger than that of the largest nail to be encountered and as, shown, is cylindrical resulting from drilling in the wooden handle 12. The length of the chamber 16 is approximately the same as that of the longest nail to be encountered.

### Method I

A first method of using the straightening hammer is illustrated in FIG. 2, A nail 24 is partially inserted in a firm material 25 which may be a wooden board 25 and is bent at 26 approximately at the surface of the board. In accordance with the method, the exposed portion of the nail is entered in the straightening chamber 16 and the handle is rotated in a direction opposite the bend, counterclockwise as indicated by the arrow 28 in FIG. 2. The wall of the chamber 16 restrains the nail against rotation as in tapping a nail above with the nailing surface of the head and the bent nail portion proceeds in a vertical plane through the required angle for straightening. A rapid and highly efficient straightening of the nail is thus achieved.

### Method II

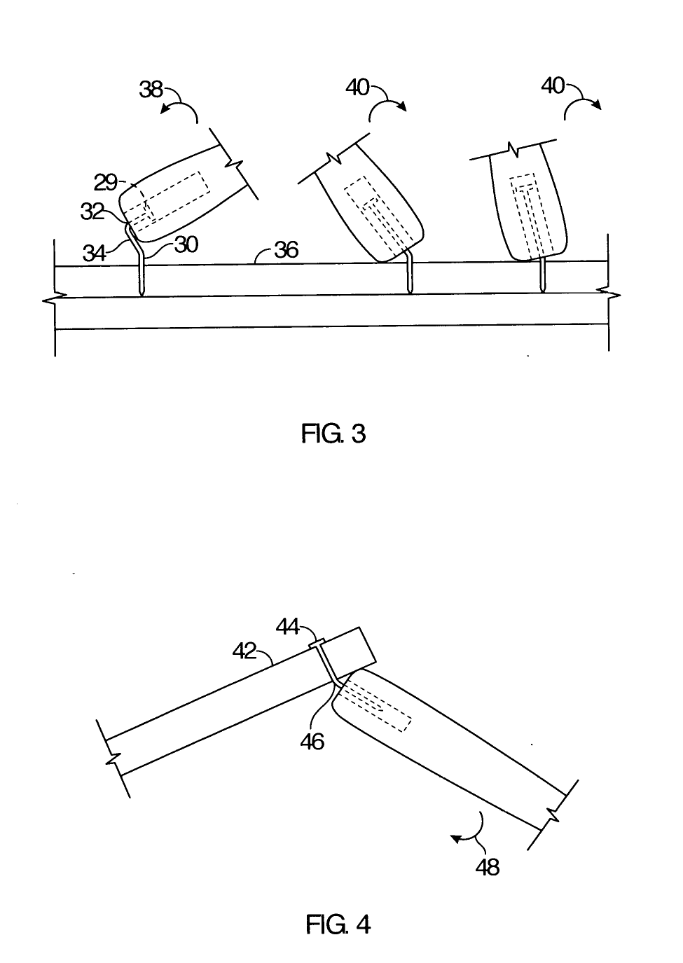

FIG. 3 shows a nail 30 with a double bend, the first at 32 spaced from board 36 and the second at 34 adjacent the surface of the board. In practicing the second method of the invention a first portion of the nail between the first bend 32 and the head 29 of the nail is entered in the straightening chamber and the handle is rotated in a direction opposite the bend, counterclockwise as at 38 in FIG. 3. Thereafter, the handle is advanced downwardly to enter the nail to the second bend 34 and the handle is rotated in a clockwise direction as at 40 to complete the straightening operation.

### Method III

The third method in FIG. 4 involves a nail driven through and bent on the reverse side of a board 42 as often occurs during demolition operations. Here again as in FIG. 1, the exposed portion of the nail is entered in the straightening chamber and the handle is rotated in the direction opposite the bend, clockwise as at 48 in FIG. 4. The nail may then be pounded out and readily withdrawn from the board 42 employing the hammer claw.

1. A nail straightening hammer comprising an elongated handle adapted for manual manipulation, a head of a hardened material fixedly secured to the handle at one end and having a substantially flat nail driving surface spaced laterally from the longitudinal centerline of the handle and substantially parallel therewith, and an elongated nail straightening chamber open at one end through the handle at its end opposite the head, the cross sectional configuration of the chamber being slightly larger than the head of the largest nail to be encountered and the length of the chamber being approximately as long as the longest nail to be encountered.

2. A nail straightening hammer as set forth in claim 1 wherein the straightening chamber opens through the opposite end surface of the hammer and extends along the longitudinal centerline of the handle.

3. A nail straightening hammer as set forth in claim 1 wherein the straightening chamber has a cylindrical cross section. 8

4. A nail straightening hammer as set forth in claim 1 wherein the head of the hammer has a nail removing claw which projects laterally opposite the nail driving face.

5. A method of using a nail straightening hammer as forth in claim 1 wherein a nail to be straightened is partially embedded in a firm material and bent approximately at the surface of the material, the method comprising the steps of entering the exposed head portion of the nail in the straightening chamber and rotating the handle manually in a direction opposite the bend until the nail returns to a straight attitude.
